(19) United States
(12) Patent Application Publication
(10) Pub. No.: US 2021/0399391 A1
(43) Pub. Date: Dec. 23, 2021

(54) BATTERY MODULE

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/347,568

(22) Filed: Jun. 14, 2021

(30) Foreign Application Priority Data
Jun. 17, 2020 (JP) 2020-104381

(51) Int. Cl. H01M 50/54; H01M 50/209; H01M 50/533

(52) U.S. Cl. CPC H01M 50/54; H01M 50/533; H01M 50/209

(57) ABSTRACT

To provide a battery module capable of improving the workability in manufacturing.

A battery module (1) includes: a plurality of battery cells (10) each including: a battery (11); and an exterior packaging body (12) that houses the battery (11). The battery (11) incudes: a negative electrode including a negative electrode current collector; an electrolyte; and a positive electrode including a positive electrode current collector. The plurality of battery cells (10) each include: a current collector tab (13, 15) extending from each of the positive electrode current collector and the negative electrode current collector; and a current collector tab lead (14, 16) connected to each of the current collector tabs (13, 15). The current collector tab lead (14, 16) extends in a vertical direction (y2) perpendicular to the stacking direction (y1) of the plurality of battery cells (10).

This application is based on and claims the benefit of priority from Japanese Patent Application No. 2020-104381, filed on 17 Jun. 2020, the content of which is incorporated herein by reference.

### BACKGROUND OF THE INVENTION

### Field of the Invention

The present invention relates to a battery module.

### Related Art

Recently, the demand for battery devices with high capacity and high output has rapidly expanded due to the spread of various electric and electronic devices of various sizes, such as automobiles, personal computers, and mobile phones.

Examples of such battery devices include a liquid battery cell that includes an organic electrolytic solution as an electrolyte between a positive electrode and a negative electrode, and a solid-state battery cell that includes a solid electrolyte instead of an electrolyte of an organic electrolytic solution.

There is known a laminated cell type in which such a battery is wrapped in a laminated film (exterior packaging body) and sealed in a plate shape.

In applications such as electric vehicles arid hybrid electric vehicles, a battery module in which a plurality of such laminated cell type battery cells are disposed and housed in a case is used. Wrapping the battery in an exterior packaging body prevents atmospheric gas from entering the battery (for example, see Patent Document 1).

Patent Document 1: PCT International Publication No. WO2019/188825

### SUMMARY OF THE INVENTION

Since the battery cell in the battery module disclosed in Patent Document 1 includes an exterior packaging body in which one film is folded back, dead space can be reduced, and the volume energy density of the battery module can be improved.

On the other hand, the bus bar is disposed in a direction in which the current collector tab lead extends, i.e., on the side face side of the battery module, and thus workability is poor when welding the bus bar and the current collector tab lead.

In response to the above issue, it is an object of the present invention to provide a battery module capable of improving the workability in manufacturing.

A first aspect of the present invention relates to a battery module, including: a plurality of battery cells each including: a battery; and an exterior packaging body that houses the battery. The battery includes: a negative electrode including a negative electrode current collector; an electrolyte; and a positive electrode including a positive electrode current collector. The plurality of battery cells each include: a current collector tab extending from each of the positive electrode current collector and the negative electrode current collector; and a current collector tab lead connected to each of the current collector tabs. The current collector tab lead extends in a vertical direction perpendicular to a stacking direction of the plurality of battery cells.

According to the first aspect, it is possible to provide a battery module capable of improving the workability in manufacturing.

In a second aspect of the present invention according to the first aspect, the battery module further includes a connecting portion that connects the current collector tab leads to one another. At least one of the current collector tab leads extends vertically upward perpendicular to the stacking direction and is connected by the connecting portion.

According to the second aspect, it is possible to more preferably improve the workability in manufacturing the battery module.

In a third aspect of the present invention according to the second aspect, the connecting portion connects the current collector tab leads adjacent to one another. The adjacent current collector tab leads that extend vertically upward perpendicular to the stacking direction and are connected to one another by the connecting portion, and the adjacent current collector tab leads that extend vertically downward perpendicular to the stacking direction and are connected to one another by the connecting portion, are provided alternately in the stacking direction.

According to the third aspect, the plurality of battery cells can be uniformly connected by the connecting portions, stacking misalignment of the plurality of battery cells can be preferably suppressed, and damage to the electrode plate can be prevented.

In a fourth aspect of the present invention according to any one of the first aspect to the third aspect, at least one of the current collector tab leads is used by bending its leading end that extends in the vertical direction.

According to the fourth aspect, the current collector tab leads can be easily connected to one another by welding or the like, and thus it is possible to more preferably improve the workability in manufacturing the battery module.

In a fifth aspect of the present invention according to any one of the first aspect to the fourth aspect, the battery cell is a solid-state battery cell.

According to the fifth aspect, it is possible to constitute a battery module while suppressing stacking misalignment of the solid-state batteries and cracking of the electrode plates.

### BRIEF DESCRIPTION OF THE DRAWINGS

FIG. 1 illustrates a perspective view of a battery module 1 according to a first embodiment;

FIG. 2 illustrates a perspective view of a battery cell 10 according to the first embodiment;

FIG. 3 illustrates a perspective view of a battery module 1a according to a second embodiment; and

FIG. 4 illustrates a perspective view of a battery cell 10a according to the second embodiment.

### DETAILED DESCRIPTION OF THE INVENTION

Embodiments of the present invention will be described below with reference to the drawings. However, the following embodiments exemplify the present invention, and the present invention is not limited to the following embodiments.

### First Embodiment

### <Battery Module>

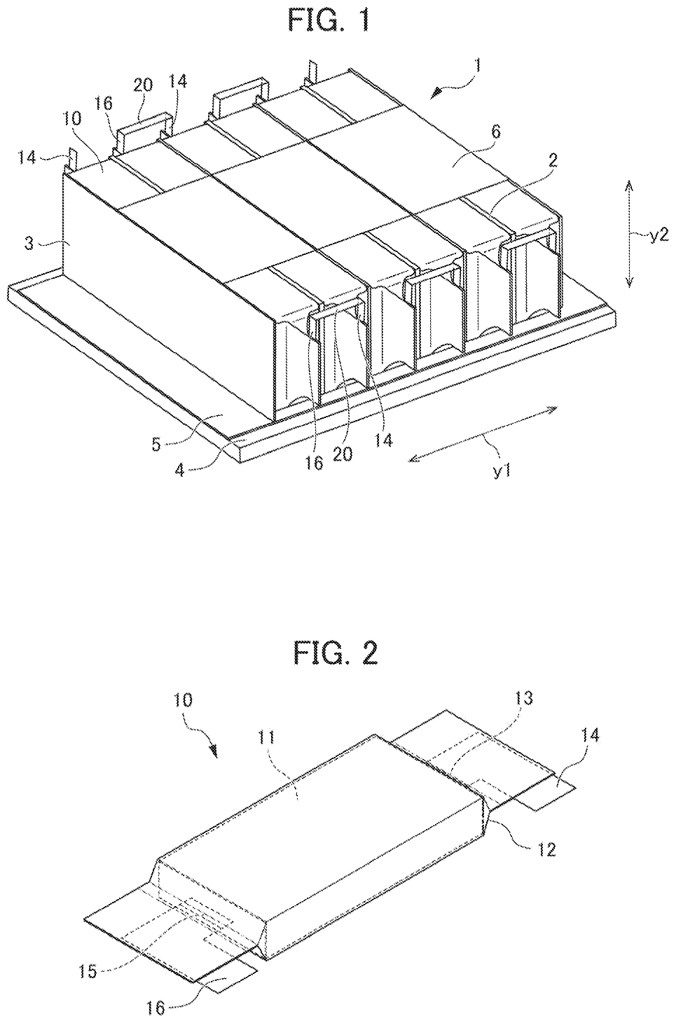

As shown in FIG. 1, a battery module 1 according to a first embodiment includes a plurality of battery cells 10, a support 2, a cooling plate 3, a mounting plate A, a vibration insulating material 5, and a fixing film 6.

The battery module 1 is constituted by the plurality of battery cells 10 stacked on and electrically connected to one another.

The plurality of battery cells 10 are stacked and disposed in the stacking direction indicated by an arrow y1 in FIG. 1.

From the plurality of battery cells 10, negative electrode current collector tab leads 14 and positive electrode current collector tab leads 16 constituting the electrodes extend outward.
The extension direction is vertically upward in a vertical direction perpendicular to the above stacking direction.
The vertical direction is indicated by an arrow y2 in FIG. 1.
The current collector tab leads adjacent to one another are electrically connected to one another by a bus bar 20 as a connecting portion.
Thus, the connecting portion can be disposed at the top of the battery module 1, and thus it is possible to improve the workability in manufacturing the battery module 1.
Further, when connecting the plurality of battery cells 10, it is possible to suppress stacking misalignment.

The plurality of battery cells 10 are connected in series, for example.

As shown in FIG. 1, the plurality of battery cells 10 are stacked on one another such that adjacent current collector tab leads are of different types.
The adjacent negative electrode current collector tab lead 14 and positive electrode current collector tab lead 16 of one of adjacent battery cells 10 are connected by the bus bar 20 as a connecting portion.
The connection method of the plurality of battery cells 10 is not limited to the above.
The plurality of battery cells 10 may be connected in parallel, for example.
In this case, the plurality of battery cells 10 are stacked so that current collector tab leads of the same type are disposed on the same end face of the battery module 1.
The current collector tab leads of the same type are electrically connected to one another.

The negative electrode current collector tab lead 14 and the positive electrode current collector tab lead 16 each may extend vertically upward and have its leading end bent so as to be substantially horizontal to the stacking direction.

Thus, the constitution of the bus bar 20 can be simplified, and also the current collector tab leads can be easily connected to the bus bar 20 more easily by welding or the like.

Next, components constituting the battery module 1 according to the present embodiment will be described.

### [Battery Cell]

As shown in FIG. 2, the battery cell 10 includes a battery 11, an exterior packaging body 12, a negative electrode current collector tab 13, a positive electrode current collector tab 15, the negative electrode current collector tab lead 13, and the positive electrode current collector tab lead 16.

In this specification, the “battery” does not include an exterior packaging body, and has a structure in which the above-described current collector tab leads are connected to a laminate described below.
The “battery cell” includes a “battery” and an exterior packaging body.

The battery 11 includes a laminate including a negative electrode including a negative electrode current collector, an electrolyte, and a positive electrode including a positive electrode current collector. The battery 11 may be a liquid battery using an organic electrolytic solution as an electrolyte, a battery including a gel electrolyte, or a solid-state battery including a flame-retardant solid electrolyte as an electrolyte.

Since the battery module 1 according to the present embodiment can suppress stacking misalignment, it is preferable that the battery 11 is a solid-state battery, which is highly susceptible to stacking misalignment.
If the battery 11 is a solid-state battery, to obtain a preferable input-output characteristics, it is necessary to bind the plurality of battery cells 10 by applying high pressure. If the stacking misalignment of the solid-state batteries occurs, uniform pressure cannot be applied to the laminates.
Therefore, when stacking misalignment occurs, the input-output characteristics and the durability are deteriorated.
In the battery module 1 according to the present embodiment, since stacking misalignment can be suppressed when the battery 11 is a solid-state battery, preferable input-output characteristics as well as high durability can be obtained.
In the following description, the battery 11 will be described as a solid-state battery.

The negative electrode includes a negative electrode current collector and a negative electrode layer formed on one surface or both surfaces of the negative electrode current collector.

The positive electrode includes a positive electrode current collector and a positive electrode layer formed on one surface or both surfaces of the positive electrode current collector.

The negative electrode current collector is not particularly limited as long as it has a function of collecting current in the negative electrode layer.

Examples of the material of the negative electrode current collector include nickel, copper, and stainless steel.
Examples of the form of the negative electrode current collector include foil, plate, mesh, and foam, and foil is preferable among than,

The negative electrode layer contains at least a negative electrode active material.

As the negative electrode active material, a material capable of occluding and releasing ions (e.g., lithium ions) can be appropriately selected and used.
Specific examples of the negative electrode active material include lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, metallic lithium, metallic indium, and lithium alloys. The negative electrode active material may be in powder form or in a thin film form.

The positive electrode current collector is not particularly limited as long as it has a function of collecting current in the positive electrode layer.

Examples of the material of the positive electrode current collector include aluminum, an aluminum alloy, stainless steel, nickel, iron, and titanium.
Among them, aluminum, an aluminum alloy, and stainless steel are preferable.
Examples of the form of the positive electrode current collector include foil, plate, mesh, and foam.
Among them, foil is preferable.

The positive electrode layer contains at least a positive electrode active material.

As the positive electrode active material, a material capable of releasing and occluding ions (e.g., lithium ions) can be appropriately selected and used.
Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂(p+q+r=1), lithium manganate (LiMn₂O₄), heterogenous element-substituted Li—Mn spinel represented by Li₁₋ᵢ₋ₓMn_{2-x-y}M_{y}O₄ (x+y=2, M is at least one selected from Al, Mg, Co, Fe, Mi, and Zn), and lithium metal phosphate (LiMPO₄, M is at least one selected from Fe, Mn, Co, and Ni).

The electrolyte is disposed between the positive electrode and the negative electrode and contains at least an electrolyte material. The electrolyte is, for example, a solid electrolyte layer formed in the form of a film.

Ionic conduction (e.g., lithium ion conduction) can be performed between the positive electrode active material and the negative electrode active material via the solid electrolyte material contained in the solid electrolyte layer.

The exterior packaging body 12 houses the battery 11.

The battery 11 is hermetically housed by the exterior packaging body 12, which can prevent atmospheric gas from entering the battery 11.

The exterior packaging body 12 consists of one film that is folded back at a side face of the battery 11 and joined so as to house the battery 11 having a substantially rectangular parallelepiped shape.

It is preferable that both ends of the film are each joined to themselves thus sandwiching the negative electrode current collector tab lead 14 and the positive electrode current collector tab lead 16. Thus, the space of the joints in the exterior packaging body 12, in which parts of the film are joined together, is reduced to suppress the formation of dead space, and the volume energy density of the battery module 1 can be effectively improved.
Alternatively, the exterior packaging body 12 may consist of two films, and may be sealed with four joints, joining the respective four edges of the two films facing each other.

The exterior packaging body 12 is formed of a film. The film is not particularly limited as long as it is a film capable of forming the exterior packaging body 12 that houses the battery 11.

It is preferable that the film that forms the exterior packaging body 12 can provide airtightness to the exterior packaging body 12.
The one film that forms the exterior packaging body 12 may be a single layer film or a laminate including a plurality of layers.

It is preferable that the film that forms the exterior packaging body 12 includes a barrier layer including an inorganic thin film such as aluminum foil, an inorganic oxide thin film such as silicon oxide or aluminum oxide, or the like, for example.

By providing the exterior packaging body 12 with the barrier layer, airtightness can be provided to the exterior packaging body 12.

It is preferable that the film that forms the exterior packaging body 12 includes a seal layer including a thermoplastic resin such as polyethylene resin.

The seal layers laminated on the films face each other and are welded to each other, whereby the films can be joined together.
Therefore, the step of applying an adhesive is unnecessary.
The film that forms the exterior packaging body 12 may not include a seal layer.
It is also possible to form the exterior packaging body 12 by bonding the films together with an adhesive.

An example of the film that forms the exterior packaging body 12 is a laminate in which a base material layer made of polyethylene terephthalate, polyethylene naphthalate, nylon, polypropylene, or the like, a barrier layer as described above, and a seal layer as described above are laminated.

These layers may be laminated via a conventionally known adhesive, or may be laminated by an extrusion coating method or the like.

The preferable thickness of the film that forms the exterior packaging body 12 varies depending on the material used for the film, but the thickness is preferably 50 μm or more, and more preferably 100 μm or more.

The thickness of the film that forms the exterior packaging body 12 is preferably 700 μm or less, and more preferably 200 μm or less.

The negative electrode current collector tab 13 and the positive electrode current collector tab 15 are configured to respectively extend from the negative electrode current collector and the positive electrode current collector respectively provided on one end face and the other end face of the battery 11.

In the present embodiment, the current collector tabs may extend from the respective current collectors.
That is, the current collector tabs may be formed by extending the respective current collectors, or may be a member different from the current collector.
The materials that can be used for the negative electrode current collector tab 13 and the positive electrode current collector tab 15 are not particularly limited, and the same materials as those conventionally used for solid-state batteries can be used.

It is preferable that the negative electrode current collector tab 13 and the positive electrode current collector tab 15 each are housed in a space formed between the portion in which the battery 11 is housed and the portion in which each current collector tab lead is housed in the exterior packaging body 12.

The space is, for example, a triangular prismatic space composed of the faces continuous with the faces joined together by sandwiching each of the negative electrode current collector tab lead 14 and the positive electrode current collector tab lead 16, and continuous with the upper and lower faces of the battery 11.
The placement of the negative electrode current collector tab 13 and the positive electrode current collector tab 15 in this space enables the battery 10 to be less susceptible to external forces and improves the durability of the battery 10.

As shown in FIG. 2, one part of each of the negative electrode-current collector tab lead 14 and the positive electrode current collector tab lead 16 is electrically connected inside the exterior packaging body 12 to each of the negative electrode current collector tab 13 and the positive electrode current collector tab 15, respectively, by welding or the like.

Another part of the tab lead is exposed from the exterior packaging body 12, to constitute an electrode portion of the battery cell 10. The material of the current collector tab lead is not particularly limited, and is preferably a flexible linear plate member such as aluminum (Al) or copper (Cu).
The shape of the part exposed from the exterior packaging body 12, of the current collector tab lead is not particularly limited, and may be a rectangular shape as shown in FIG. 2, another polygonal shape, a shape having a curved part, or the like.

The negative electrode current collector tab lead 14 and the positive electrode current collector tab lead 16 each extend in a direction different from a direction in which the connected current collector tab extends from the battery 11, and are exposed from the exterior packaging body 12.

As shown in FIG. 2, in the present embodiment, the negative electrode current collector tab lead 14 and the positive electrode current collector tab lead 16 each extend in a direction substantially perpendicular to a direction in which the connected negative electrode current collector tab 13 or positive electrode current collector tab 15 extends from the battery 11.
In the present embodiment, the negative electrode current collector tab lead 14 and the positive electrode current collector tab lead 16 extend in the same direction.

### [Support]

The support 2 is a plate member that supports the battery cell 10 and prevents the battery cell 10 from being damaged.

The support 2 is sandwiched between adjacent battery cells 10.
The support 2 is in contact with the exterior packaging body 12 of the battery cell 10 to support, a face of the battery cell 10, thereby preventing the battery cell 10 from being damaged.
The support 2 may be configured to support the current collector tab or the current collector tab lead.
The material of the support 2 is not particularly limited, and a metal, a resin, or the like can be used.
As the support 2, a metal having a high thermal conductivity is preferably used.
Thus, heat generated from the battery cell 10 can be efficiently dissipated.

### [Cooling Plate]

The cooling plate 3 dissipates heat generated from the battery cell 10 by way of contact between the cooling plate 3 and the battery cell 10.

In the present embodiment, the cooling plates 3 are disposed at both ends of the stacked battery cells 10.
In addition to the above, the cooling plate 3 may be disposed on the mounting face of the battery cell 10, between adjacent battery cells 10, or the like.
The material of the cooling plate 3 is not particularly limited, and is preferably a material having high thermal conductivity such as metal.

### [Mounting Plate]

The plurality of battery cells 10 are mounted on the mounting plate 4.

The material, of the mounting plate 4 is not particularly limited, and is preferably a material having high thermal conductivity such as metal.
Thus, it is possible to effectively prevent the battery cell 10 from being damaged, and to effectively dissipate heat generated from the battery cell 10.

### [Vibration Insulating Material]

The vibration insulating material 5 is disposed on the upper face of the mounting plate 4.

The plurality of battery cells 10 are mounted on the upper face of the mounting plate 4 via the vibration insulating material 5.
Mounting the plurality of battery cells 10 via the vibration insulating material 5 can effectively suppress vibration of the battery cells 10.
As the material of the vibration insulating material 5, a conventionally known material as a vibration insulating material, such as urethane rubber or silicone rubber, is used.

### [Fixing Film]

The fixing film 6 fixes the plurality of battery cells 10. The fixing film 6 can effectively prevent the battery cells 10 from being damaged.

The material of the fixing film 6 is not particularly limited, and examples thereof include a paper, a cloth, a film (cellophane, OPP, acetate, polyimide, PVC, or the like), and an adhesive tape composed of a metal foil or the like.

### Second Embodiment

A battery module 1a according to a second embodiment of the present invention will be described below.

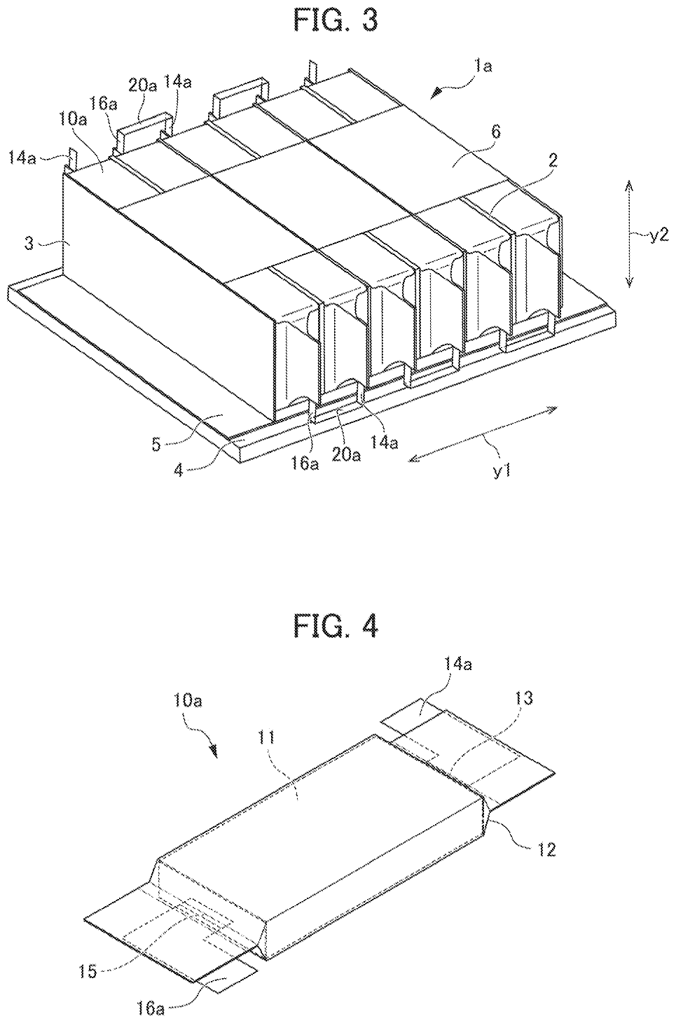

In the following description, description of portions common to those of the first embodiment may be omitted.
As shown in FIG. 3, the battery module 1a includes a plurality of battery cells 10a.

The plurality of battery cells 10a are stacked and disposed in the stacking direction indicated by an arrow y1 in FIG. 3.

In the present embodiment, bus bars 20a each as connecting portions that connect a negative electrode current collector tab lead 14a and a positive electrode current collector tab lead 16a adjacent to one another are provided alternately in the stacking direction.
That is, pairs of adjacent negative electrode current collector tab lead 14a and positive electrode current collector tab lead 16a that extend vertically upward in the vertical direction indicated by an arrow y2 in FIG. 3 and are connected by the bus bars 20a, and pairs of the adjacent current collector, tab leads that extend vertically downward and are connected similarly, are alternately provided in the stacking direction y1.
Thus, in the battery module 1a, it is possible to equalise the pressure applied to the plurality of battery cells 10a when the plurality of battery cells 10a are connected by the bus bar 20a and fixed.
Therefore, the stacking misalignment of the battery cells 10a can be preferably suppressed.

As shown in FIG. 4, the battery cell 10a includes the negative electrode current collector tab lead 14a connected to the negative electrode current collector tab 13 and the positive electrode current collector tab lead 16a connected to the positive electrode current collector tab 15.

As shown in FIG. 4, the negative electrode current collector tab lead 14a and the positive electrode current collector tab lead 16a each extend in a direction substantially perpendicular to a direction in which the connected current collector tab extends from the battery 11.

The extending directions of the negative electrode current collector tab lead 14a and the positive electrode current collector tab lead 16a are opposite to each other.
In the battery module 1a formed by stacking the battery cells 10a having the above structure, the bus bars 20a as connecting portions can be provided alternately in the stacking direction.

Although the preferable embodiments of the present invention have been described above, the present invention is not limited to the embodiments, and any suitable modifications within a range that does not hinder the effect of the present invention are also included in the scope of the present invention.

### EXPLANATION OF REFERENCE NUMERALS

1, 1a battery module
10, 10a battery cell
12 exterior packaging
13 negative electrode current collector tab (current collector tab)
14 negative electrode current collector tab lead (current collector tab lead)
15 positive electrode current collector tab (current collector tab)
16 positive electrode current collector tab lead (current collector tab lead)
20 bus bar (connecting portion)
y1 stacking direction
y2 vertical direction

What is claimed is:

1. A battery module, comprising:
a plurality of battery cells each comprising: a battery; and an exterior packaging body configured to house the battery,
the battery comprising: a negative electrode comprising a negative electrode current collector; an electrolyte; and a positive electrode comprising a positive electrode current collector,
the plurality of battery cells each comprising: a current collector tab extending from each of the positive electrode current collector and the negative electrode current collector; and a current collector tab lead connected to each of the current collector tabs, and the current collector tab lead extending in a vertical direction perpendicular to a stacking direction of the plurality of battery cells.

2. The battery module according to claim 1, further comprising a connecting portion configured to connect the current collector tab leads to one another, and
at least one of the current collector tab leads extending vertically upward perpendicular to the stacking direction and being connected by the connecting portion.

3. The battery module according to claim 2,
wherein the connecting portion is configured to connect the current collector tab leads adjacent to one another, and
wherein the adjacent current collector tab leads configured to extend vertically upward perpendicular to the stacking direction and be connected to one another by the connecting portion, and the adjacent current collector tab leads configured to extend vertically downward perpendicular to the stacking direction and be connected to one another by the connecting portion, are provided alternately in the stacking direction.

4. The battery module according to claim 1, wherein at least one of the current collector tab leads is used by bending its leading end that extends in the vertical direction.

5. The battery module according to claim 1, wherein the battery cell is a solid-state battery cell.
